(19) United States
(12) Patent Application Publication
(10) Pub. No.: US 2018/0301033 A1
(43) Pub. Date: Oct. 18, 2018

(54) SAFE DRIVING ASSISTANCE SYSTEM AND IN-VEHICLE UNIT

(71) Applicant: RENESAS ELECTRONICS CORPORATION, Tokyo (JP)

(72) Inventor: Daisuke OSHIDA, Tokyo (JP)

(21) Appl. No.: 15/899,987

(22) Filed: Feb. 20, 2018

(30) Foreign Application Priority Data
Apr. 13, 2017 (JP) 2017-080120

(51) Int. Cl. G08G 1/16

(52) U.S. Cl. CPC G08G 1/161

(57) ABSTRACT

A stopped vehicle cannot transmit position information about a subject vehicle by disabling communication. The vehicle-to-vehicle communication cannot therefore detect the position information about the stopped vehicle. A safe driving assistance system includes a first vehicle, a second vehicle, and an infrastructure. The second vehicle can transmit and receive position information from the first vehicle each other. The infrastructure includes a roadside unit that can receive position information about the first vehicle and position information about the second vehicle, can transmit position information about the first vehicle to the second vehicle, and can transmit position information about the second vehicle to the first vehicle. The infrastructure detects that the first vehicle stops, based on communication with the first vehicle, and transmits position information about the stopped first vehicle to the second vehicle.

### CROSS-REFERENCE TO RELATED APPLICATIONS

The disclosure of Japanese Patent Application No. 2017-080120 filed on Apr. 13, 2017 including the specification, drawings and abstract is incorporated herein by reference in its entirety.

### BACKGROUND

The present disclosure relates to a safe driving assistance system and is applicable to a safe driving assistance system to detect a stopped vehicle, for example.

ITS (Intelligent Transport Systems) safe driving assistance wireless systems include a vehicle-to-vehicle communication system (V2V) and a road-to-vehicle communication system (V2I). The vehicle-to-vehicle communication system assists in safe driving at blind intersections by using wireless communication that allows vehicles to exchange information with each other. The road-to-vehicle communication system assists in safe driving by using radio-based wireless communication that allows a roadside unit to supply information (such as traffic light information, regulation information, and pedestrian information) from an infrastructure to a vehicle. The vehicle-to-vehicle communication system and the road-to-vehicle communication system directly perform intercommunication between vehicles and between a road and a vehicle without the use of cloud computing. A communication system including the vehicle-to-vehicle communication system and the road-to-vehicle communication system is referred to as V2X.

Recently, there is an increasing interest in V2X-based safe driving assistance. In this system, a vehicle broadcasts its position information about the subject vehicle. Another vehicle receiving the information determines a collision hazard based on its own position information and the received position information about the different vehicle and notifies a driver of the hazard.

Patent Literature 1: Japanese Unexamined Patent Application Publication No. 2016-143092

### SUMMARY

A stopped vehicle cannot transmit the position information about the subject vehicle by stopping the communication. The vehicle-to-vehicle communication therefore cannot detect the position information about the stopped vehicle. These and other objects and novel features maybe readily ascertained by referring to the following description of the present specification and appended drawings.

A representative overview of the present disclosure is concisely described as follows. A safe driving assistance system is capable of the vehicle-to-vehicle communication and the road-to-vehicle communication. An infrastructure uses the road-to-vehicle communication to detect a stop state of a first vehicle and transmits position information about the stopped first vehicle to a second vehicle.

The above-mentioned safe driving assistance system can detect position information about a stopped vehicle.

### BRIEF DESCRIPTION OF THE DRAWINGS

FIG. 1 is a diagram illustrating issues of a safe driving assistance system using V2X;

FIG. 2 is a diagram illustrating a safe driving assistance system according to a working example;

FIG. 3 is a block diagram illustrating the configuration of the vehicle in FIG. 2;

FIG. 4 is a block diagram illustrating the configuration of major components of the vehicle in FIG. 2;

FIG. 5 is a block diagram illustrating the configuration of the in-vehicle unit in FIG. 4;

FIG. 6 is a block diagram illustrating the configuration of the control circuit in FIG. 5;

FIG. 7 is a block diagram illustrating the configuration of the terminal unit in FIG. 3;

FIG. 8 is a block diagram illustrating the configuration of the roadside unit in FIG. 2;

FIG. 9 is a conceptual diagram illustrating system operation of the safe driving system in FIG. 2;

FIG. 10 is a flowchart illustrating system operation of the safe driving system in FIG. 2;

FIG. 11 is a flowchart illustrating operation of the in-vehicle unit in FIG. 4;

FIG. 12 is a diagram illustrating an example list of stopped vehicles provided for the infrastructure in FIG. 2;

FIG. 13 is a diagram illustrating the configuration of a message;

FIG. 14 is a block diagram illustrating the configuration of a vehicle according to a first modification;

FIG. 15 is a block diagram illustrating the configuration of the in-vehicle unit in FIG. 14;

FIG. 16 is a block diagram illustrating the configuration of a vehicle according to a second modification;

FIG. 17 is a flowchart illustrating operation of the in-vehicle unit in FIG. 16;

FIG. 18 is a flowchart illustrating operation of a roadside unit according to the second modification;

FIG. 19 is a diagram illustrating an encrypted message as an application;

FIG. 20 is a conceptual diagram illustrating system operation of the safe driving system according to a third modification;

FIG. 21 is a flowchart illustrating system operation of the safe driving system according to the third modification; and

FIG. 22 is a flowchart illustrating the determination of vehicle stop in FIG. 21.

### DETAILED DESCRIPTION

An in-vehicle unit for the present V2X consumes a large amount of power. A battery mounted on the vehicle is drained if the position information about the subject vehicle is notified while the vehicle stops. The engine of the vehicle cannot start by using a self-starter. A safe driving assistance system using the present V2X therefore disables the communication for a vehicle that stops by turning off the ignition. Such a vehicle is not detected as a stopped vehicle. The communication is enabled for a vehicle that stops by turning on the ignition in such a case as idle stop (idle reduction). The notion of stop described in the present specification also includes parking as well as stopping defined in traffic laws.

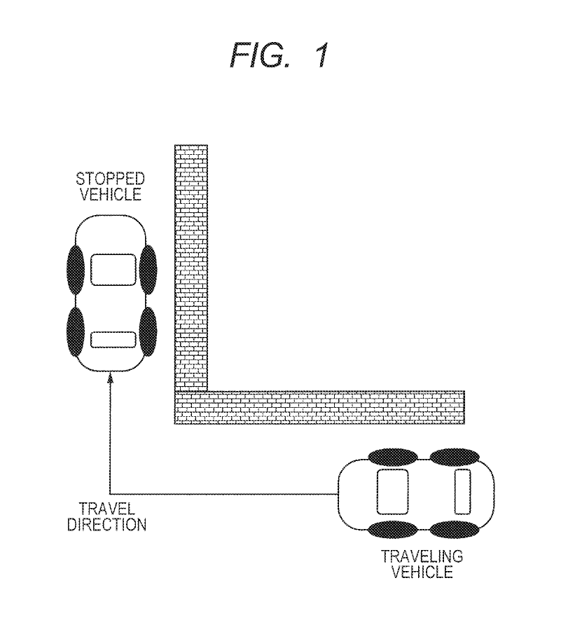

Detection of a stopped vehicle therefore depends on the roadside unit or an active sensor such as a camera or a radar of the traveling vehicle. However, the camera or the radar of the traveling vehicle is useless for the detection at a blind corner as illustrated in FIG. 1. The brake operation may fail after the active sensor detects a vehicle stopping ahead of the corner.

The safe driving assistance system according to the embodiment uses the road-to-vehicle communication to detect a vehicle stopping at an infrastructure including roadside units such as a traffic light and a road sign and delivers the position information from the infrastructure to the vehicle.

The infrastructure detects whether the vehicle stops, based on communication information acquired immediately before the stopped vehicle stops the communication. Detection means are exemplified as follows. (1) The power supply is not turned off for a predetermined period when the ignition turns off. The in-vehicle unit performs the final communication (to transmit a message containing vehicle stop information). The infrastructure receives the vehicle stop information and determines that the vehicle stops (working example). (2) The in-vehicle unit for V2X is mounted with a small battery. The in-vehicle unit performs the final communication (to transmit a message containing vehicle stop information) when the ignition turns off. The infrastructure receives the vehicle stop information and determines that the vehicle stops (first modification). (3) The in-vehicle unit transmits a pre-message for stop in a stop preparation state indicating that a transmission gear is positioned to parking or a parking brake (side brake or foot brake) is operated. The infrastructure receives the pre-message for stop and determines that the vehicle stops if no new message is received within a predetermined period (second modification). (4) The infrastructure determines that the vehicle stops if the vehicle does not update coordinates of the position information for a predetermined period and loses the communication (third modification). The infrastructure saves the position information when receiving a stop signal (a message containing the vehicle stop information or a stop pre-message). The position information may be contained in a message containing the vehicle stop information or a stop pre-message or may be contained in a message in the last ordinary communication. The message may contain the time when the vehicle stops.

According to the embodiment, the position information about the stopped vehicle is transmitted from the infrastructure that is always supplied with the power. The position information can be acquired without draining the stopped vehicle battery. It is possible to greatly contribute to prevention of collision accidents.

The working example and the modifications will be described with reference to the accompanying drawings. In the description below, the same constituent elements are designated by the same reference numerals and a repetitive explanation may be omitted for simplicity.

Working Example

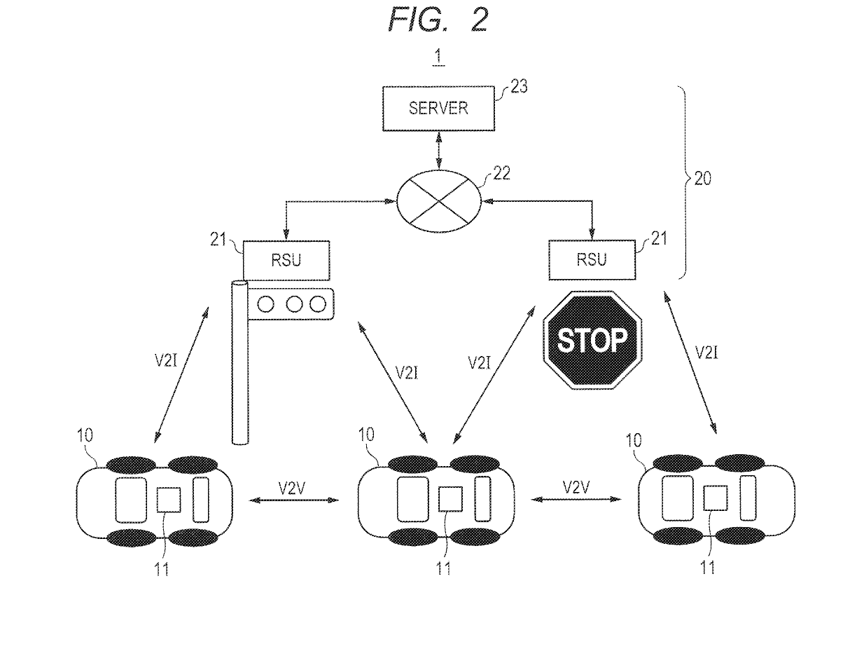

The description below explains an example configuration of the V2X-based safe driving assistance system with reference to FIG. 2. FIG. 2 is a conceptual diagram illustrating an example configuration of the safe driving assistance system according to the working example.

A safe driving assistance system 1 includes a vehicle 10 and an infrastructure 20. The vehicle 10 is mounted with a unit (in-vehicle unit) 11 compliant with V2X systems. The infrastructure 20 includes a roadside unit (RSU) 21 such as a traffic light and a road sign, a network 22, and a server 23. The safe driving assistance system 1 administers the position information about vehicles and therefore uses a GPS (Global Positioning System) satellite, for example. Available communications include vehicle-to-vehicle communication (V2V) between the vehicle 10 and the vehicle 10 and road-to-vehicle communication (V2I) between the vehicle 10 and the infrastructure 20.

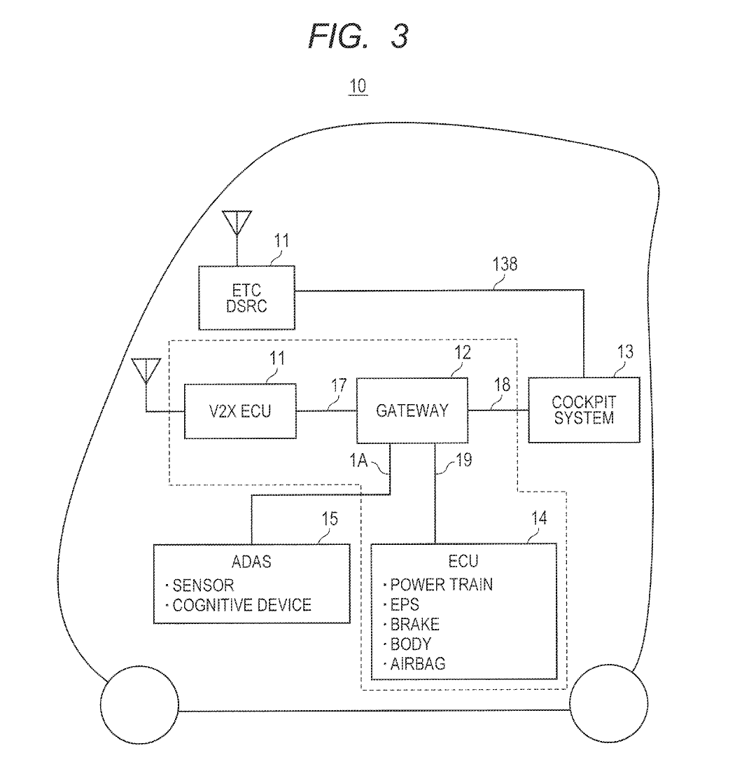

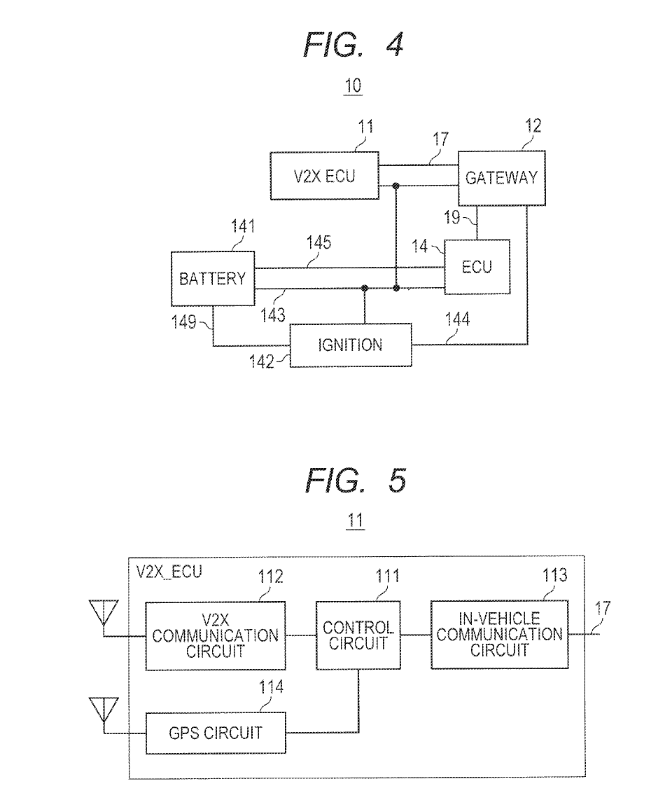

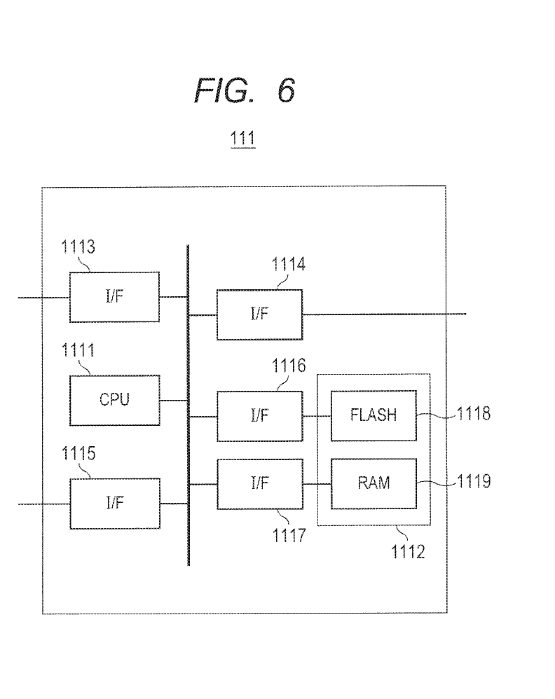

A configuration inside the vehicle including the in-vehicle unit will be described with reference to FIGS. 3 through 6. FIG. 3 is a block diagram illustrating the configuration inside the vehicle according to the working example. FIG. 4 is a block diagram illustrating the configuration of major parts inside the vehicle in FIG. 3 and corresponds to the configuration enclosed in the broken line in FIG. 3. FIG. 5 is a block diagram illustrating the configuration of the in-vehicle unit in FIG. 4. FIG. 6 is a block diagram illustrating the configuration of the control circuit in FIG. 5.

As illustrated in FIG. 3, the vehicle 10 includes: a gateway 12 to connect the in-vehicle unit 11 with a different in-vehicle network; a terminal unit 13 as a cockpit system; an electronic control unit (ECU) 14 of the vehicle 10; an in-vehicle unit (ADAS) 15 compliant with Advanced Driver Assistance System (ADAS) ; and an in-vehicle unit (ETC DSRC) 16 compliant with Dedicated Short Range Communications (DSRC) for Electronic Toll Collection System (ETC).

The control system 14 includes: a powertrain system to control transmission systems including an engine, a clutch, a transmission, and a propeller shaft; an electric power steering (EPS) system; a brake system; a body system (BODY) including a power window, an automatic air conditioner, a seat position control to adjust to a driver; a headlight aiming control linked to steering wheel angles, and an anti-theft control; and an airbag system. The electronic control unit (ECU) controls each of these.

The in-vehicle unit 15 is connected to the gateway 12 via a signal line 1A and includes a cognitive device to recognize pedestrians or obstacles by using sensors such as a smart camera, a radar, a lidar (light detection and ranging or laser imaging detection and ranging), and an ultrasound system.

The in-vehicle unit 11 as well as the in-vehicle unit 16 is assumed to be part of ITS (Intelligent Transport Systems) applications and visually provides the cockpit with collision risk information. Cooperation with the cognitive device of the in-vehicle unit 15 may provide information needed for automatic control of the vehicle.

As illustrated in FIG. 4, the vehicle 10 includes: an in-vehicle unit (V2X ECU) 11 for V2X communication; a main battery (storage battery) 141 for the vehicle; an ignition 142 to start driving the vehicle; and various types of electronic control unit (ECU) 14. The in-vehicle unit 11 is connected to the ECU 14 via a communication line 17, the gateway 12, and a communication line 19. The battery 141 is connected to the in-vehicle unit 11, the gateway 12, the ignition 142, and the ECU 14 via a power line 143. A signal from the ignition 142 is transmitted to the ECU 14 via the signal line 144, the gateway 12, and the communication line 19 and is transmitted to a power control circuit (unshown) to control power supply of the battery 141 via a signal line 149.

As illustrated in FIG. 5, the in-vehicle unit 11 includes a control circuit 111, a V2X communication circuit 112, an in-vehicle communication circuit 113, and a GPS circuit 114.

As illustrated in FIG. 6, the control circuit 111 includes a CPU (Central Processing Unit) 1111, a storage circuit 1112, and interface circuits (I/F) 1113 through 1117. The storage circuit 1112 includes nonvolatile memory 1118 and volatile memory 1119, for example. The nonvolatile memory 1118 is available as flash memory, for example. The nonvolatile memory 1118 stores a control program and a computer program that detects positions of the different vehicle 10, determines a hazardous vehicle, and performs processes such as driving support. The volatile memory 1119 is available as RAM such as SRAM (Static Random Access Memory), for example, and temporarily stores various data resulting from arithmetic processing of the CPU 1111. The interface circuit 1113 is connected to the V2X communication circuit 112. The interface circuit 1114 is connected to the GPS circuit 114. The interface circuit 1115 is connected to the in-vehicle communication circuit 113.

The control circuit 111 receives position information about the subject vehicle 10 detected by the GPS circuit 114 and position information about the different vehicle 10 received via the V2X communication circuit 112. The control circuit 111 receives position information about the stopped vehicle 10 transmitted from the roadside unit 21. The control circuit 111 receives in-vehicle information such as an ignition state, a gear state, and a parking brake state from various types of ECUs 14.

The control circuit 111 transmits position information about the subject vehicle 10 to the V2X communication circuit 112. The control circuit 111 uses the vehicle-to-vehicle communication or the road-to-vehicle communication to transmit various types of information to the V2X communication circuit 112 of the different vehicle 10 and the V2X communication circuit 212 of the roadside unit 21.

The V2X communication circuit 112 performs vehicle-to-vehicle communication with the V2X communication circuit 112 of the different vehicle. The V2X communication circuit 112 also performs road-to-vehicle communication with the V2X communication circuit 212 of the roadside unit 21. The V2X communication circuit 112 performs wireless communication according to a predetermined communication protocol based on IEEE802.11p, for example. The wireless communication uses frequency bands of 5.9 GHz and 700 MHz but is not limited thereto.

The in-vehicle communication circuit 113 transmits and receives information in accordance with protocols such as CAN (Controller Area Network), LIN (Local Interconnect Network), FlexRay, MOST (Media Oriented Systems Transport), in-vehicle Ethernet, Ethernet AVB (Audio Video Bridging), and CAN-FD (CAN with Flexible Data Rate). Various types of ECUs 14 are connected to the communication line 17 connected to the in-vehicle communication circuit 113 via the gateway 12, for example. The gateway 12 is needed for bridging because a plurality of ECUs, if used, require different protocols and communication rates.

The GPS circuit 114 exemplifies a position detection circuit that detects positions of the subject vehicle 10. The GPS circuit 114 includes a GPS receiver. The GPS receiver and a GPS satellite configure a GPS system. The GPS receiver receives radio waves from an artificial satellite and specifies the position of the GPS circuit 114 itself, namely, the position of the vehicle 10 mounted with the GPS circuit 114. The position of the vehicle 10 is represented by latitudes and longitudes, for example. The GPS circuit 114 adds time information to the position information about the detected vehicle 10 and outputs the position information to the control circuit 111. The time information indicates the time when the position of the vehicle 10 is detected.

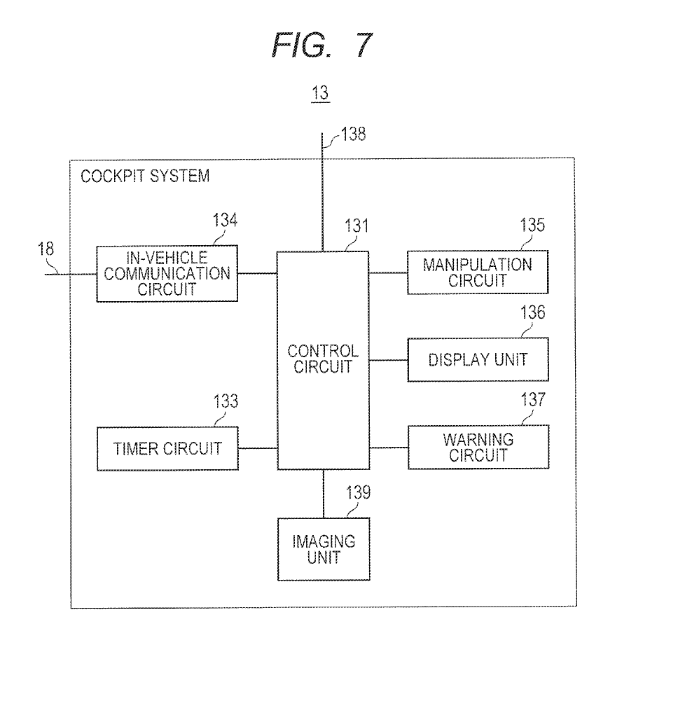

A terminal unit will be explained with reference to FIG. 7. FIG. 7 is a block diagram illustrating an example configuration of the terminal unit in FIG. 3. The terminal unit 13 includes a control circuit 131 that includes a CPU and a storage circuit similar to those used for the control circuit 111. The control circuit 131 connects with a timer circuit 133, an in-vehicle communication circuit 134, a manipulation circuit 135, a display unit 136, a warning circuit 137, and an imaging unit 139 such as a view camera.

The control circuit 131 may perform part of processes (such as a driving assistance process) performed by the control circuit 111.

The in-vehicle communication circuit 134 is connected to the ECU 14 and the in-vehicle unit 11 via the communication line 18 and the gateway 12. The in-vehicle communication circuit 134 transmits and receives information in accordance with a protocol (any one of the protocols) similar to that used for the in-vehicle communication circuit 113.

The manipulation circuit 135 corresponds to a manipulation panel including a touch sensor and a manipulation button provided for the display unit 136, for example.

The display unit 136 is available as a liquid crystal display or an organic EL display. The display unit 136 displays in real time the different vehicle 10, a pedestrian, a road image at an intersection, and a hazardous vehicle around the subject vehicle 10 in accordance with manipulation on the control circuit 151.

The warning circuit 137 corresponds to a speaker or a warning light to warn about the presence of a hazardous vehicle or a pedestrian, for example. The control circuit 131 outputs an audio signal to the speaker and can thereby audibly warn a driver of the vehicle 10 about the presence of a hazardous vehicle or a pedestrian. The control circuit 131 turns on the warning light or displays information on the display unit 136 and can thereby similarly warn the driver about the presence of a hazardous vehicle or a pedestrian.

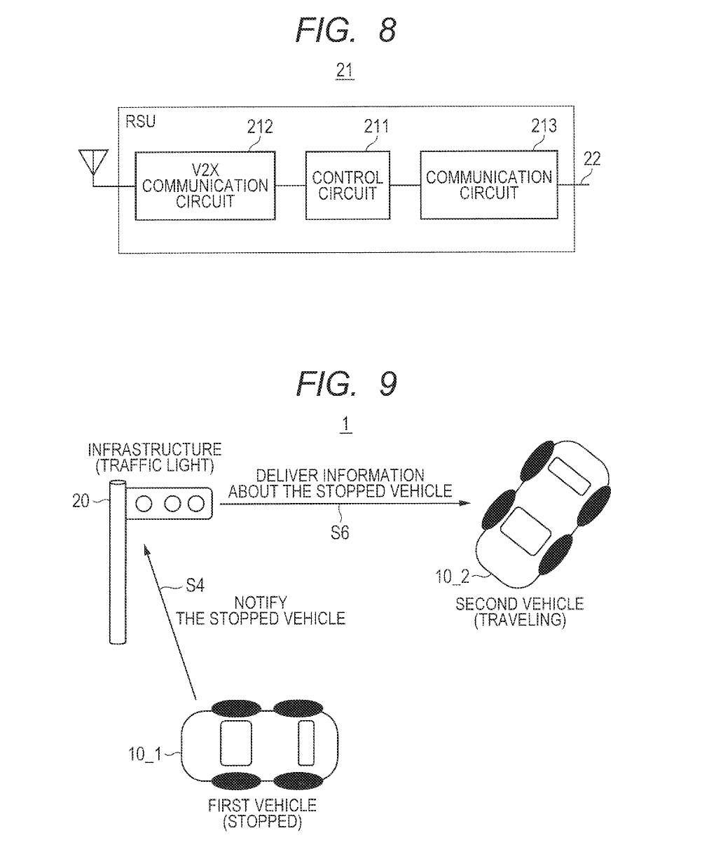

A roadside unit will be explained with reference to FIG. 8. FIG. 8 is a block diagram illustrating a configuration of the roadside unit in FIG. 2.

The roadside unit 21 includes a control circuit 211, a V2X communication circuit 212, and a communication circuit 213.

The control circuit 211 is configured similarly to the control circuit 111 of the in-vehicle unit 11 and includes the CPU and the storage circuit.

The V2X communication circuit 212 is configured similarly to the V2X communication circuit 112 of the in-vehicle unit 11. The V2X communication circuit 212 is capable of transmitting various information to the V2X communication circuit 112 in accordance with predetermined communication protocol and is capable of receiving the information transmitted from the V2X communication circuit 112. For example, the V2X communication circuit 212 transmits position information about a stopped vehicle to the in-vehicle unit 11 based on the vehicle stop information received from the stopped vehicle.

The communication circuit 213 transmits and receives information in accordance with the Ethernet protocol, for example. The server 23 is connected to the network 22 connected to the communication circuit 213, for example.

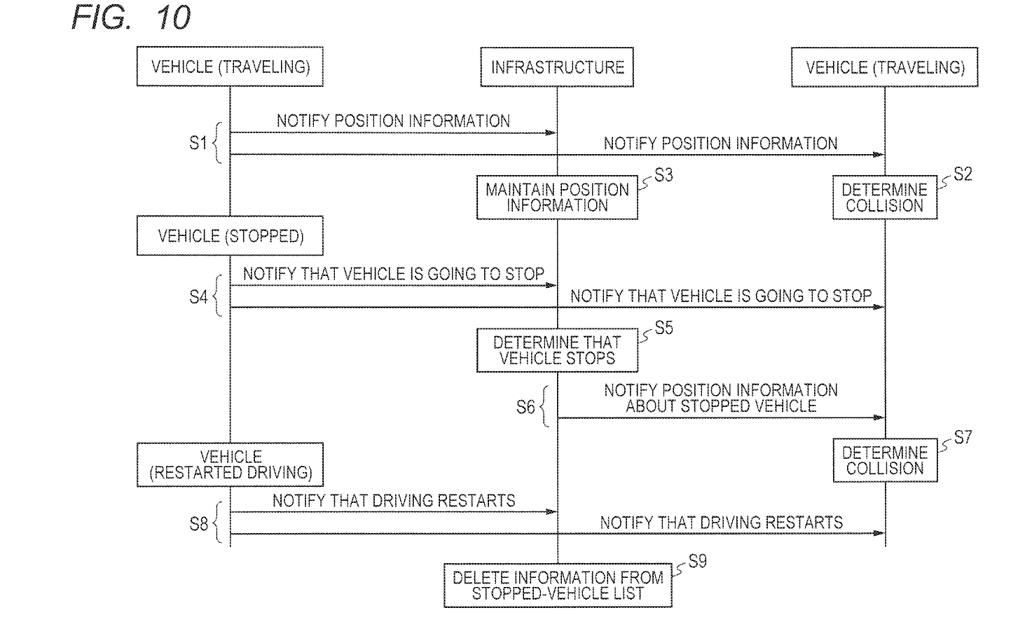

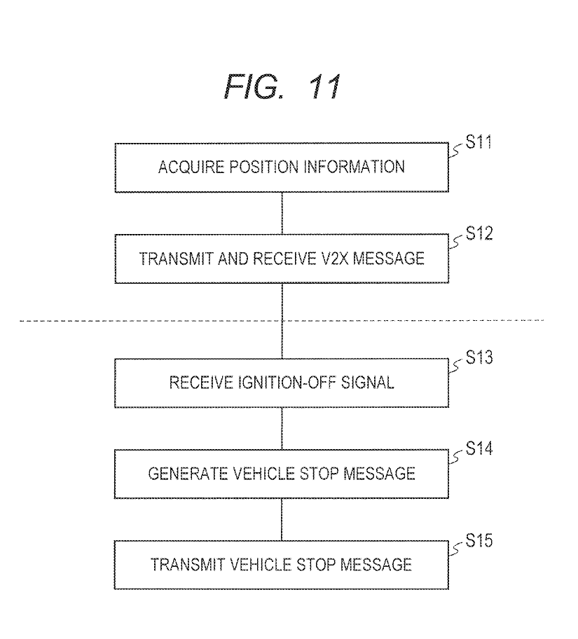

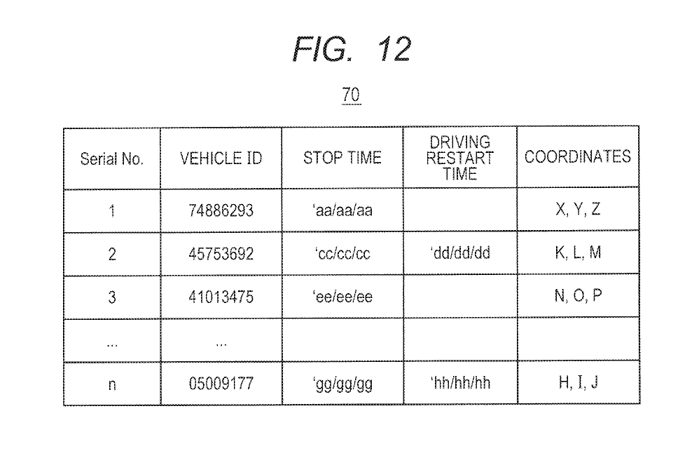

The description below explains system operation of the safe driving assistance system according to the working example with reference to FIGS. 9 through 12. FIG. 9 is a conceptual diagram illustrating system operation of the safe driving assistance system in FIG. 2. FIG. 10 is a flowchart illustrating system operation of the safe driving assistance system in FIG. 9. FIG. 11 is a flowchart illustrating operation of the in-vehicle unit in FIG. 4. FIG. 12 is a diagram illustrating an example list of stopped vehicles provided for the infrastructure in FIG. 2.

The V2X communication broadcasts a message corresponding to the subject vehicle information while the vehicle is traveling. The vehicle (such as a first vehicle 10_1) transmits a message including the position information to the infrastructure 20 and another vehicle (such as a second vehicle 10_2) at one-time transmission (S1). The other vehicle (second vehicle 10_2) determines a collision hazard based on the received position information and the position information about itself and notifies the driver of a warning (S2). The infrastructure 20 maintains the position information (S3).

The vehicle (such as the first vehicle 10_1) transmits no message while stopping. The other vehicle (such as the second vehicle 10_2) therefore cannot acquire the position information. In this case, the vehicle (first vehicle 10_1) transmits a message (vehicle stop information) notifying that the vehicle is going to stop (S4). At this time, the vehicle (first vehicle 10_1) may transmit the position information as well as the vehicle stop information. The vehicle (first vehicle 10_1) may not transmit the position information as well as the vehicle stop information. In such a case, the position information about the stopped vehicle (first vehicle 10_1) is assumed to equate with position information about the vehicle (first vehicle 10_1) during the communication before the communication to transmit the vehicle stop information. When receiving the vehicle stop information, the infrastructure 20 determines that the vehicle (first vehicle 10_1) stops (S5), and then periodically delivers the position information about the stopped vehicle (first vehicle 10_1) (S6). The infrastructure 20 registers the information about the stopped vehicle to a stopped-vehicle list 70 to be described. The other vehicle (second vehicle 10_2) also receives the vehicle stop information but does nothing based on the vehicle stop information and therefore discards the vehicle stop information. The other vehicle (second vehicle 10_2) determines a collision hazard based on the position information about the stopped vehicle (first vehicle 10_1) received from the infrastructure 20 and the position information about the subject vehicle (second vehicle 10_2) and notifies the collision hazard to the driver (S7).

The stopped vehicle (first vehicle 10_1) restarts driving by delivering a message (driving restart information) notifying that the driving restarts (S8). The infrastructure 20 receives the message notifying the driving restart information from the stopped vehicle (first vehicle 10_1) and, at this time point, deletes the information about the vehicle (first vehicle 10_1) having restarted the driving from the stopped-vehicle list 70 maintained in the infrastructure 20 (S9). The other vehicle (second vehicle 10_2) also receives the driving restart information but does nothing based on the driving restart information and therefore discards the driving restart information. The infrastructure 20 need not continuously issue the vehicle stop information after the stopped vehicle (first vehicle 10_1) restarts driving. It is possible to avoid causing inconsistency in the system.

The description below explains the stopped-vehicle list 70 maintained in the infrastructure 20 with reference to FIG. 12. A serial number (Serial No) corresponds to a numeric value optionally specifiable at the infrastructure 20. A vehicle ID provides an identification number assigned to the stopped vehicle and is registered as a vehicle ID 311 to be described. The infrastructure 20 further maintains a stop time and a restart time for each vehicle in the form as illustrated in FIG. 11. For example, suppose the vehicle corresponding to serial number 2 has restarted driving. The infrastructure 20 then deletes the information about this vehicle from stopped-vehicle information delivered from the infrastructure 20. The infrastructure 20 may continue to maintain the information about the vehicle having restarted driving. For example, it is possible to survey at which position and how long the vehicle stops for the purpose of comprehending traffic situations and to provide criteria for maintaining and improving parking facilities and roads. In this case, the stopped-vehicle information is ideally stored in a server 23 for unified management as well as the roadside unit 21.

The vehicle needs to forward (the infrastructure needs to recognize) information (such as the vehicle stop information) about the stopped vehicle in terms of the system operation according to the working example. The most desirable technique is to allow the driver to indicate the intention of the driver, namely, the intention to stop the vehicle when the vehicle stops. However, the notification is often supposed to fail because the driver forgets the notification, hurries, or feels the notification inconvenient. There is a need for a mechanism that allows the in-vehicle unit to automatically issue the notification.

The working example supplies the power to the in-vehicle unit 11 for a predetermined period (predetermined time) even after the ignition 142 is turned off. During this period, the in-vehicle unit 11 delivers a message notifying that the vehicle stops. The description below explains the vehicle to do this with reference to FIG. 4.

The in-vehicle unit 11 acquires the position information from the GPS circuit 114 when the ignition is turned on while the vehicle travels (S11). The in-vehicle unit 11 delivers a V2X message containing the position information (S12). The V2X message is delivered from the traveling vehicle.

The ECU 14 determines whether the ignition 142 is turned on or off. The ECU 14 controls a power control circuit of the battery 141 from the signal line 145 to control the power supply from the battery 141. The ECU 14 detects that the ignition 142 is turned off. The ECU 14 then controls the battery 141 to supply the power to the in-vehicle unit 11, the ECU 14, and the gateway 12 for a predetermined period. The ECU 14 notifies the in-vehicle unit 11 that the ignition 142 is turned off. The in-vehicle unit 11 receives the signal indicating that the ignition 142 is turned off (S13). The in-vehicle unit 11 then generates a vehicle stop message (S14) and delivers the vehicle stop message (S15). The vehicle delivers the vehicle stop message when the vehicle stops. The vehicle 10 can thereby reliably notify the vehicle stop information to the infrastructure 20.

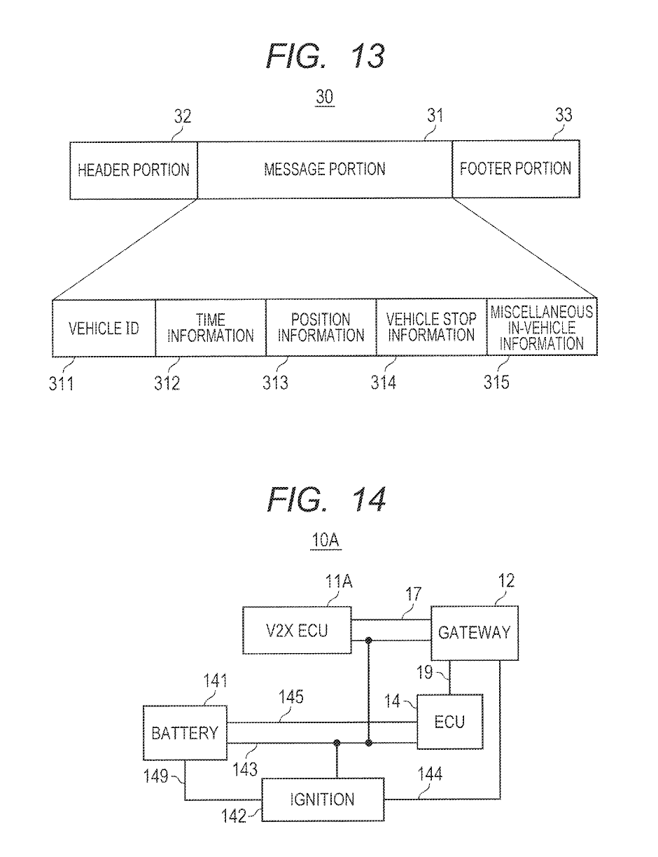

The description below explains a data structure (message) of information transmitted and received between vehicles and between a road and a vehicle using FIG. 13. FIG. 13 is a conceptual diagram illustrating the configuration of a message.

Presently, V2X systems are being standardized in North America, Europe, and Japan based on unique methods and formats. Actual message sets vary with countries. The description below exemplifies an abstracted message as the concept. Information (message) 30 is transmitted and received between vehicles and between a road and a vehicle and includes a header portion 32 and a footer portion 33 before and after a message portion 31. The message portion 31 includes the vehicle ID 311 to identify the subject vehicle 10, time information 312, position information 313 about the subject vehicle 10, vehicle stop information 314, and miscellaneous in-vehicle information 315.

The traveling vehicle 10 writes the position information 313 about the subject vehicle to the message portion 31 and broadcasts the message. The vehicle 10 going to stop writes the vehicle stop information 314 about the subject vehicle to the message portion 31 and broadcasts the message. The infrastructure 20 writes the position information 313 about the stopped vehicle 10 to the message portion 31 and broadcasts the message.

While there has been described the case of stopping one vehicle for the sake of simplicity, the message portion may contain the position information about a plurality of vehicles.

The working example generates no message while the vehicle stops, making it possible to acquire the position information about the vehicle whose position information was unidentifiable and to avoid collision with a vehicle stopping at a blind corner.

Modifications

Typical modifications will be described below. The following description of the modifications assumes that the same reference symbols as used for the above-mentioned working example are used for the parts including the configuration and the function similar to those explained in the above-mentioned working example. The description of the above-mentioned working example is applicable to the description of those parts as needed within a technologically undeviating scope. Parts of the above-mentioned working example and all or part of the modifications are interchangeably applicable as needed within a technologically undeviating scope.

First Modification

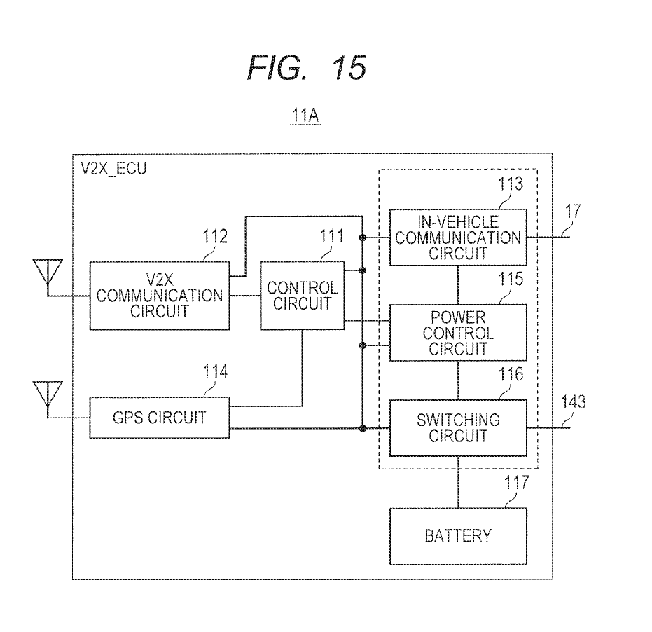

The description below explains a vehicle and an in-vehicle unit according to a first modification with reference to FIGS. 14 and 15. FIG. 14 is a block diagram illustrating the configuration in the vehicle according to the first modification. FIG. 15 is a block diagram illustrating the configuration of the in-vehicle unit in FIG. 14.

In a vehicle 10A according to the first modification, an in-vehicle unit 11A is mounted with a small battery 117, detects an off-state of the ignition 142 if applicable, then uses the power from the battery 117, and delivers a message (vehicle stop message) notifying that the vehicle stops.

As illustrated in FIG. 14, the vehicle 10A is configured similarly to the vehicle 10. The vehicle 10A includes a switching circuit 116 and the battery 117 as illustrated in FIG. 15. The power is supplied to circuits in the in-vehicle unit 11A via the switching circuit 116. A microcontroller (MCU) may be used to configure the power control circuit 115, the switching circuit 116, and the in-vehicle communication circuit 113.

The power control circuit 115 may receive a signal indicating the off state of the ignition 142 via the signal line 144, the gateway 12, and the communication line 17. The power control circuit 115 then supplies the power to the control circuit 111 and the V2X communication circuit 112 from the built-in battery 117 and notifies the control circuit 111 that the ignition 142 is turned off. The operation during the off state of the ignition 142 equals that described in the working example. The vehicle 10A can thereby reliably notify the vehicle stop information to the infrastructure 20. The in-vehicle unit 11A delivers the vehicle stop message and then controls the switching circuit 116 to stop supplying the power from the battery 117.

Second Modification

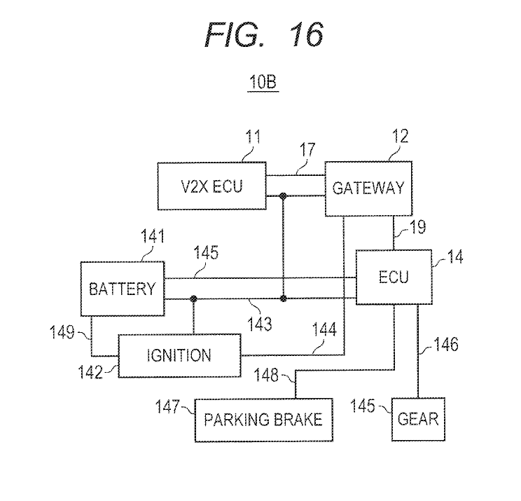

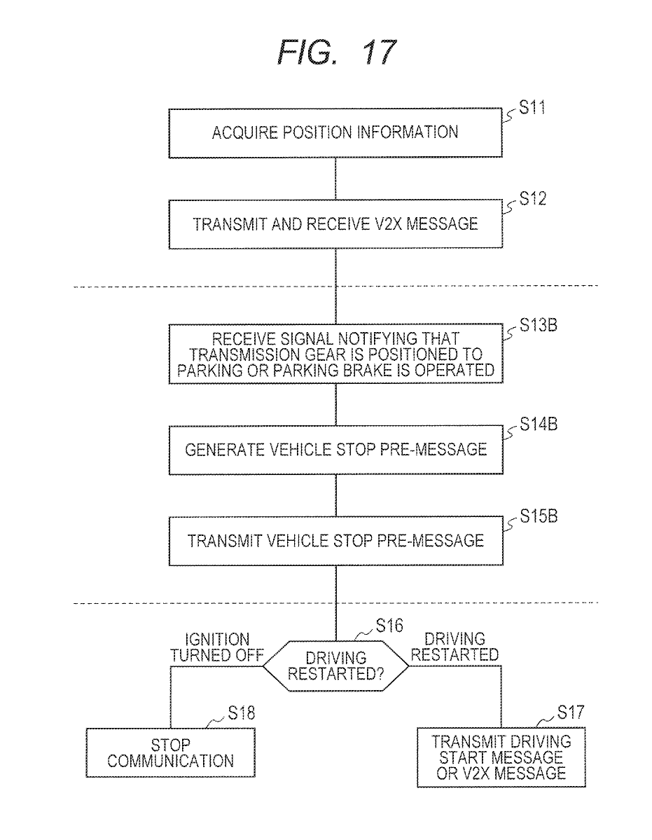

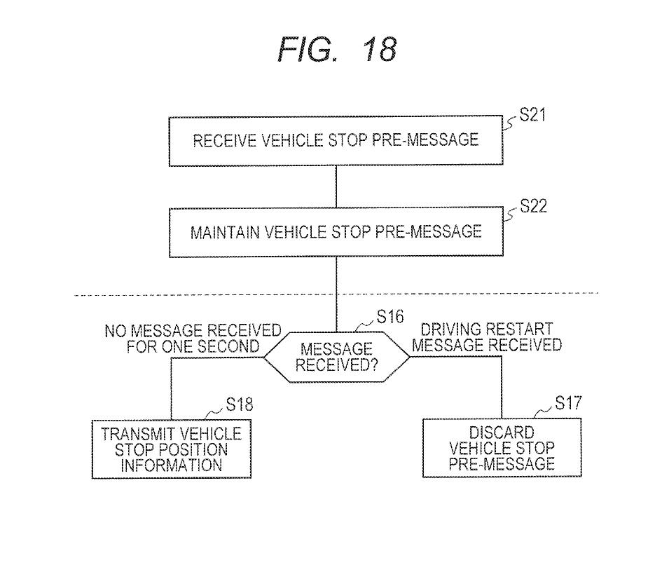

The description below explains a vehicle and an in-vehicle unit according to a second modification with reference to FIGS. 16 through 18. FIG. 16 is a block diagram illustrating the configuration in a vehicle according to the second modification. FIG. 17 is a flowchart illustrating operation of the in-vehicle unit in FIG. 16. FIG. 18 is a flowchart illustrating operation of a roadside unit according to the second modification.

According to the second modification, the in-vehicle unit delivers the vehicle stop information as a pre-message when a transmission gear is positioned to parking or a parking brake (side brake or foot brake) is operated.

As illustrated in FIG. 16, a vehicle 10B is configured similarly to the vehicle 10 but differs in that the ECU 14 connects with a transmission gear 145 via a signal line 146 and with a parking brake 147 via a signal line 148.

The control circuit 111 allows the in-vehicle communication circuit 113 to receive a signal transmitted from the ECU 14 notifying that a transmission gear 145 is positioned to parking or a parking brake (side brake or foot brake) 147 is operated (S13B). Based on this, the process generates a message (vehicle stop pre-message) notifying a pre-stop state (a state immediately before the vehicle stops) (S14B). The vehicle stop pre-message is transmitted (S15B). In this case, the in-vehicle unit 11 continues to transmit the message (vehicle stop pre-message) until the transmission gear 145 is moved from parking, the parking brake 147 is released, or the ignition 142 is turned off. The process determines whether the transmission gear 145 is moved from the parking position or the parking brake 147 is released (to restart driving) (S16). The process switches to transmission of an ordinary V2X message (S17) if the driving restarts. At this time, the process may first transmit a message (driving start message) notifying that the vehicle 10 restarts driving. The process stops the communication if the ignition 142 is turned off (S18).

The infrastructure 20 (roadside unit 21) receives the vehicle stop pre-message (S21) and maintains the vehicle stop pre-message (S22). The roadside unit 21 determines whether a message is received (S23). The process determines that the vehicle stops if the message transmission is lost for a predetermined period (such as one second). The process then starts transmitting stop position information about the stopped vehicle (S24). The process discards the vehicle stop pre-message (S25) if an ordinary V2X message or a driving restart message is received. The vehicle 10B can thereby reliably notify the vehicle stop information to the infrastructure 20.

Third Modification

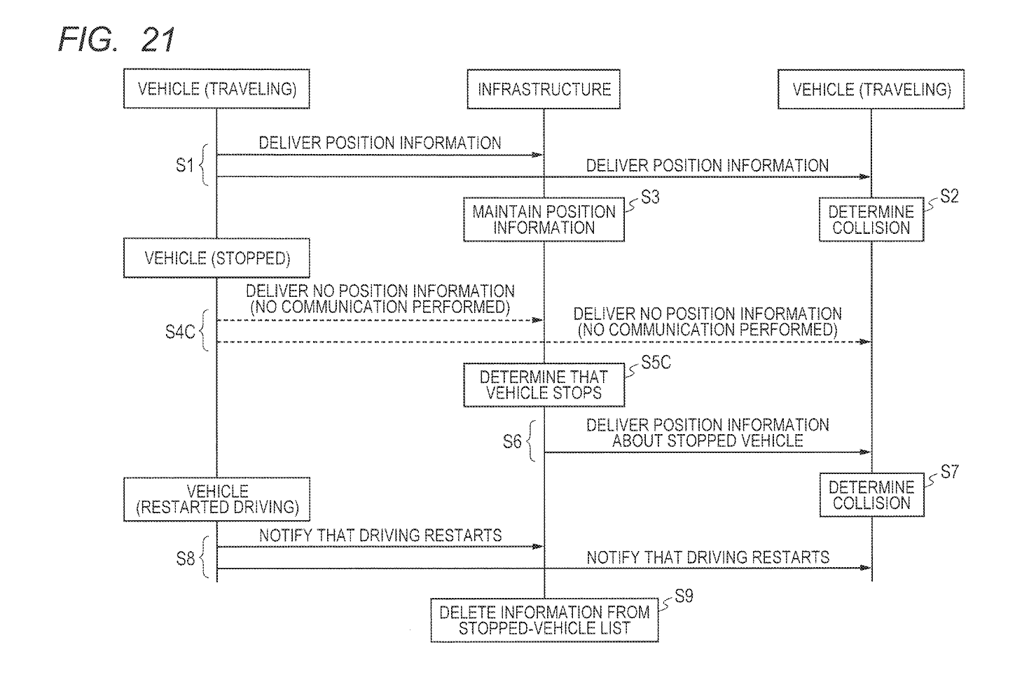

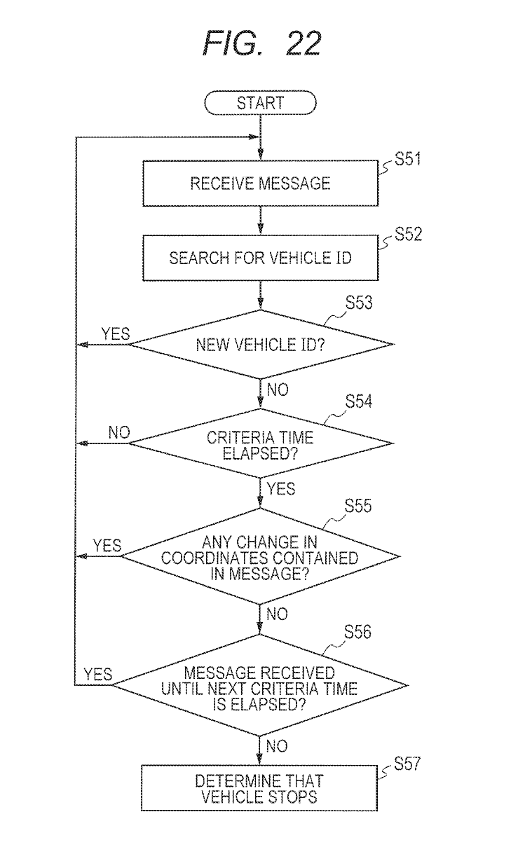

The description below explains system operation of the safe driving assistance system according to a third modification with reference to FIGS. 20 through 22. FIG. 20 is a conceptual diagram illustrating system operation of the safe driving system according to the third modification. FIG. 21 is a flowchart illustrating system operation of the safe driving system according to the third modification; and FIG. 22 is a flowchart illustrating the determination of stop in FIG. 21.

While the vehicle travels, a message is transmitted similarly to the system operation according to the working example.

While the vehicle stops, the vehicle (such as the first vehicle 10_1) transmits no message (S4C). The other vehicle (such as second vehicle 10_2) cannot acquire the position information. In this case, the infrastructure 20 determines that the vehicle (first vehicle 10_1) stops (S5C) by detecting that the vehicle (first vehicle 10_1) does not deliver the position information within a predetermined time. At this time, the position information about the vehicle (first vehicle 10_1) available during the last communication is assumed to be the position information about the stopped vehicle (first vehicle 10_1). The infrastructure 20 periodically delivers the position information about the stopped vehicle (first vehicle 10_1) (S6). The vehicle (second vehicle 10_2) receives the position information, determines a collision hazard, and notifies it to the driver based on the position information about the stopped vehicle (first vehicle 10_1) received from the infrastructure 20 and the position information about the subject vehicle (second vehicle 10_2) (S7). The vehicle 10 can notify the infrastructure 20 that the subject vehicle stops, without the need for a special apparatus or mechanism. When the driving restarts, the system operation is similar to that of the working example.

The description below explains the determination of vehicle stop at S5C with reference to FIG. 22. The infrastructure 20 receives a message (S51) and then searches for a vehicle ID (S53). The infrastructure 20 determines whether the vehicle ID is new (the message corresponds to the same vehicle). The process returns to S51 if the vehicle ID is new (YES). The process confirms whether criteria time (determination criterion) elapses if the vehicle ID is not new (S54). The infrastructure 20 returns to S51 if the criteria time does not elapse (NO). The infrastructure 20 confirms whether there is a change in coordinates contained in the message (S55) if the criteria time elapses (YES). The infrastructure 20 returns to S51 if there is a change in coordinates contained in the message (YES). The infrastructure 20 confirms whether a message is received until the next criteria time is elapsed (S56) if there is no change in coordinates contained in the message (NO). The infrastructure 20 returns to S51 if a message is received until the next criteria time is elapsed (YES). The infrastructure 20 determines that the vehicle stops (S57) if no message is received until the next criteria time is elapsed (NO).

The vehicle stop is determined by detecting that the position information is not changed within the predetermined time. It is necessary to settle a criteria time that prevents a traveling vehicle from being assumed to be stopping. Presently, the V2X communication is standardized as 10 Hz (ten times per second). A wait for at least one second ensures ten times of the communication. The V2X communication is capable of a distance ranging from several hundred meters to several kilometers. For example, the vehicle running at 200 km/hr. travels approximately 55 meters per second. The update of coordinates can be detected by confirming the update during one second. The vehicle can be determined to stop when the communication is lost though no change is made to coordinates based on the criteria time of one second. The criteria time is not limited to one second and may be long enough to be capable of detecting an update on the coordinate for a traveling vehicle. The vehicle is determined to stop also when the vehicle stops without turning off the ignition and when the vehicle moves at a level that does not update the coordinate.

Application

An application of the safe driving assistance system will be explained. As illustrated in FIG. 13, the message 30 contains time information 312 and a vehicle ID 311 in addition to the position information 313. The stopped-vehicle list contains stop time and driving restart time. It is possible to acknowledge the time (from the stop time to the driving restart time) during which the vehicle stops. The vehicle ID contained to identify the vehicle makes it possible to acknowledge the stop situation of each particular vehicle.

Acknowledging the stop situation of each particular vehicle makes it possible to place regulations on a parking violation, for example. It is thereby possible to decrease the frequency of cruising to place regulations on a parking violation, reduce the fuel consumption of patrol cars, and help reduce the CO₂ emission.

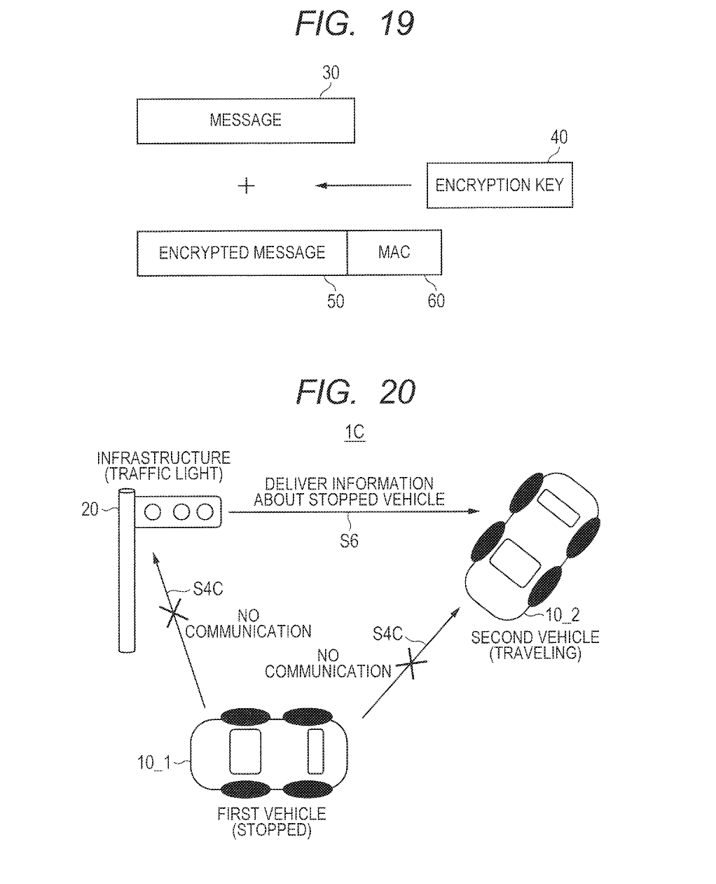

The message 30 contains a signature. As illustrated in FIG. 19, an encryption key 40 is used to encrypt the message 30 containing the saved vehicle identification ID, the position information, the time information, and the signature. MAC (Media Authentication Code) 60 is added to an encrypted message 50. It is possible to prove that the message is not falsified. Placing regulations on a parking violation is possible without visually confirming the actual vehicle. If a vehicle is stolen, it is possible to narrow the range of the time for a road surveillance system by confirming the time when the theft occurred.

While there has been described the embodiment, the working example, the modifications, and the application of the present invention created by the inventors, it is to be distinctly understood that the present invention is not limited to the embodiment, the working example, the modifications, and the application, but may be otherwise variously modified.

For example, the GPS circuit 114 provided for the in-vehicle unit 11 may be provided for a navigation system, a terminal unit, or an ECU. The in-vehicle unit 11 connected to the gateway 12 is not limited thereto but may be connected to an ECU or an infotainment device (to provide information and entertainment).

An off state of the ignition is detected by the ECU 14 but may be detected by the power control circuit of the battery 141.

What is claimed is:

1. A safe driving assistance system comprising:
a first vehicle;
a second vehicle that can transmit and receive position information from the first vehicle each other; and
an infrastructure including a roadside unit that can receive position information about the first vehicle and position information about the second vehicle, can transmit position information about the first vehicle to the second vehicle, and can transmit position information about the second vehicle to the first vehicle,
wherein the infrastructure detects a stop state of the first vehicle based on communication with the first vehicle and transmits position information about the stopped first vehicle to the second vehicle.

2. The safe driving assistance system according to claim 1,
wherein the second vehicle determines collision based on position information about the stopped first vehicle and position information about a subject vehicle.

3. The safe driving assistance system according to claim 2,
wherein, when an ignition turns off, the first vehicle does not turn off a power supply for a predetermined time period and transmits vehicle stop information notifying that a subject vehicle stops, and
wherein the infrastructure determines that the first vehicle stops, based on the vehicle stop information.

4. The safe driving assistance system according to claim 3,
wherein the infrastructure transmits position information about the stopped first vehicle to the second vehicle and registers information about the stopped first vehicle to a stopped-vehicle list.

5. The safe driving assistance system according to claim 4,
wherein the first vehicle, when restarting driving, transmits driving restart information notifying that a subject vehicle restarts driving, and
wherein the infrastructure deletes information about a first vehicle from the stopped-vehicle list based on the driving restart information.

6. The safe driving assistance system according to claim 3,
wherein the first vehicle is provided with an in-vehicle unit including:
a position detection circuit that detects position information about a subject vehicle;
a control circuit that generates a message to be transmitted based on position information about the subject vehicle; and
a communication circuit that transmits the message and receives a message from a different vehicle, and
wherein the control circuit generates a vehicle stop message containing the vehicle stop information based on a signal indicating an off state of the ignition and the communication circuit transmits the vehicle stop message.

7. The safe driving assistance system according to claim 6,
wherein the first vehicle further includes a storage battery having a power control circuit, and
wherein the power control circuit supplies power from the storage battery for a predetermined time period when the ignition turns off.

8. The safe driving assistance system according to claim 6,
wherein the first vehicle further includes a storage battery and an electronic control unit, and
wherein an electronic control unit supplies power from the storage battery for a predetermined time period when the ignition turns off.

9. The safe driving assistance system according to claim 2,
wherein the first vehicle includes an in-vehicle unit having a storage battery and transmits vehicle stop information notifying that a subject vehicle stops when an ignition turns off, and
wherein the roadside unit determines that the first vehicle stops, based on the vehicle stop information.

10. The safe driving assistance system according to claim 9,
wherein the infrastructure transmits position information about the stopped first vehicle to the second vehicle and registers information about the stopped first vehicle to a stopped-vehicle list.

11. The safe driving assistance system according to claim 10,
wherein the first vehicle, when restarting driving, transmits driving restart information notifying that a subject vehicle restarts driving, and
wherein the infrastructure deletes information about a first vehicle from the stopped-vehicle list based on the driving restart information.

12. The safe driving assistance system according to claim 9,
wherein the first vehicle is provided with an in-vehicle unit including:
a position detection circuit that detects position information about a subject vehicle;
a control circuit that generates a message to be transmitted based on position information about the subject vehicle;
a communication circuit that transmits the message and receives a message from a different vehicle; and
a power control circuit,
wherein the power control circuit supplies power from the storage battery to the control circuit and the communication circuit based on a signal indicating an off state of the ignition, and
wherein the control circuit generates a vehicle stop message containing the vehicle stop information based on a signal indicating an off state of the ignition and the communication circuit transmits the vehicle stop message.

13. The safe driving assistance system according to claim 2,
wherein the first vehicle transmits a vehicle stop pre-message indicating a state of a subject vehicle being ready to stop in one of cases of positioning a transmission gear to parking and operating a parking brake,
wherein the first vehicle stops communication when the ignition turns off,
wherein one of a driving start message and a message is transmitted when driving restarts, and
wherein the infrastructure determines that the first vehicle stops, based on the vehicle stop information.

14. The safe driving assistance system according to claim 13,
wherein the infrastructure transmits position information about the stopped first vehicle to the second vehicle and registers information about the stopped first vehicle to a stopped-vehicle list.

15. The safe driving assistance system according to claim 14,
wherein the first vehicle, when restarting driving, transmits driving restart information notifying that a subject vehicle restarts driving, and
wherein the infrastructure deletes information about a first vehicle from the stopped-vehicle list based on the driving restart information.

16. The safe driving assistance system according to claim 13,
wherein the first vehicle is provided with an in-vehicle unit including:
a position detection circuit that detects position information about a subject vehicle;
a control circuit that generates a message to be transmitted based on position information about the subject vehicle; and
a communication circuit that transmits the message and receives a message from a different vehicle, and
wherein the control circuit generates the vehicle stop pre-message in one of cases of positioning the transmission gear to parking and operating the parking brake and the communication circuit transmits the vehicle stop pre-message.

17. An in-vehicle unit to perform vehicle-to-vehicle communication and road-to-vehicle communication, comprising:
a position detection circuit that detects position information;
a control circuit that generates a message to be transmitted based on the position information; and
a communication circuit that transmits the message and receives a message from a different vehicle,
wherein the control circuit generates a vehicle stop message containing the vehicle stop information notifying a subject vehicle coming to a stop based on a signal indicating an off state of an ignition and the communication circuit transmits the vehicle stop message.

18. The in-vehicle unit according to claim 17, further comprising:
a storage battery and a power control circuit,
wherein the power control circuit supplies power from the storage battery to the control circuit and the communication circuit based on off state of an ignition.

19. The safe driving assistance system according to claim 2,
wherein the infrastructure determines that the first vehicle stops when position information about the first vehicle is not updated within a predetermined time period.

20. The safe driving assistance system according to claim 19,
wherein each of the first vehicle and the second vehicle includes an in-vehicle unit including:
a position detection circuit that detects position information about a subject vehicle;
a control circuit that generates a message to be transmitted based on position information about the subject vehicle; and
a communication circuit that transmits the message and receives a message from a different vehicle.
